(19) United States
(12) Patent Application Publication
(10) Pub. No.: US 2005/0262943 A1
(43) Pub. Date: Dec. 1, 2005

(54) Apparatus, methods, and systems to detect an analyte based on changes in a resonant frequency of a spring element

(76) Inventors: Glenn Claydon, Wynantskill, NY (US); Stacey Goodwin, Niskayuna, NY (US); Anis Zribi, Rexford, NY (US); Wei-Cheng Tian, Clifton Park, NY (US); Aaron Knobloch, Clifton Park, NY (US); Walter V. Cicha, Schenectady, NY (US); Patrick R. L. Malenfant, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/854,845

(22) Filed: May 27, 2004

(51) Int. Cl. G01N 29/04

(52) U.S. Cl. 73/579

(57) ABSTRACT

According to some embodiments, a Microelectromechanical System (MEMS) sensor includes a sensing material on a spring element. The sensor may also include a detector adapted to determine a resonant frequency associated with the spring element, wherein the resonant frequency changes upon the exposure of the sensing material to an analyte.

### BACKGROUND

The scientific and technological interest in miniaturized, multi-parameter (e.g., gas, humidity, chemical, temperature, biological, and pressure) sensor devices has grown in recent years. The need for such devices spans a wide range of industries and applications, such as the medical instrumentation, food and agriculture, paper, automotive, electric appliance, petrochemical, and semiconductor industries, as well as the military, in, for example, gas, humidity, chemical, temperature, biological, and pressure sensing applications. The wide range of environments to which these devices are exposed may limit the candidate materials that can be used to build the devices. A number of gas, humidity, chemical, temperature, biological, and pressure sensor devices have been developed and built for specific applications. However, these devices do not demonstrate a suitable combination of robustness, sensitivity, selectivity, stability, size, simplicity, reproducibility, reliability, response time, resistance to contaminants, and longevity. Thus, what are still needed, in general, are multi-gas, vapor, and biological sensor devices, among other sensor devices, that exploit the unique properties of certain thin films and nano and pico sized structures, including their adjustable pore size, customized functionality, high surface area, high adsorption/desorption rate under optimized conditions, high chemical stability, and mass and stress changes associated with the physisorption of gas and vapor molecules.

Power consumption, response time, mechanical strength, and crosstalk between unit sensor devices are major areas of concern with respect to stress, strain, mass change, and thermally-sensitive Microelectromechanical Systems (MEMS), such as gas, humidity, chemical, temperature, and pressure sensor devices, as well as calorimeter and microheater resonant devices, in general. For example, lower power consumption may be desired for portable and wireless devices. Response time and sensitivity may be critical in many sensing applications, such as in sensing warfare agents, measuring low dew points, detecting trace gases, etc., but may be difficult to optimize with conventional multi-gas and vapor sensor devices without making sacrifices with respect to other performance parameters. Power consumption and crosstalk between unit sensor devices may be affected by the rigidity of the resonating structure. Typically, resonant devices are actuated electrostatically, which requires high voltages or very narrow gaps on order of a few hundred nanometers between the driving electrodes in order to generate high enough forces that would deflect a spring element (e.g., a membrane, a cantilever, or a diaphragm). While high voltages suggest high power consumption, controlling very narrow gaps in a repeatable and reliable manner requires complex fabrication processes and very tight fabrication tolerances that may ultimately drive the sensor cost too high. Thus, resonant MEMS that are built with highly compliant materials with low power consumption actuators and very sensitive and low response time read out mechanisms may provide low power consumption, sensitive, and fast response time read out mechanisms.

Two additional areas of concern are raised with respect to miniaturized vapor (e.g., humidity) sensor devices, among other sensor devices. First, the sensing films associated with such vapor sensor devices may become significantly swollen while at relatively high humidity due to their high affinity for water vapor. The swelling of these sensing films generates lateral stresses that impinge upon the thin membranes, potentially breaking them. Second, sensing films having larger surface areas are desired in order to reduce the thickness of the sensing films at a given mass. Reducing the thickness of the sensing films and incorporating nanostructures (e.g., nano-spheres, nano-rods, nano-fibers, etc.) into the sensing materials decreases the diffusion time constant of the water adsorption/desorption, reducing the response time of the vapor sensor devices. Thus, what are needed are micro-machined resonant gas and vapor sensor devices, among other sensor devices, that utilize, for example, high-aspect ratio silicon microstructures etched adjacent to the thin membranes. These silicon microstructures may serve as stress relievers at varying vapor (e.g., humidity) levels and provide large surface areas for the sensing films, increasing the sensitivity of the vapor sensor devices.

### SUMMARY

According to some embodiments, a resonant MEMS sensor includes a sensing material on a spring element. The sensor may also include a detector adapted to determine a resonant frequency associated with the spring element, wherein the resonant frequency changes upon the exposure of the sensing material to an analyte.

### BRIEF DESCRIPTION OF THE DRAWINGS

FIG. 1 is a block diagram overview of a MEMS resonant sensor.

FIG. 2A is a perspective view of a MEMS apparatus constructed in accordance with an exemplary embodiment of the invention.

FIG. 2B is a side view of the spring element of FIG. 2A when a uniform Lorentz force is applied.

FIG. 3 is a graph illustrating an output of a sensor when an analyte is not present. In particular, it indicates a resonant frequency of a spring element.

FIG. 4 is a perspective view of a MEMS apparatus constructed in accordance with an exemplary embodiment of the invention.

FIG. 5 is a graph illustrating a change in the resonant frequency of a spring element when a sensing material is exposed to an analyte.

FIG. 6 illustrates a method of detecting when an analyte is present according to an exemplary embodiment of the invention.

FIG. 7 illustrates a method of fabricating a MEMS resonant sensor in accordance with an exemplary embodiment of the invention.

FIGS. 8 through 10 illustrate intermediate stages of MEMS resonant sensor fabrication according to an exemplary embodiment of the invention.

FIG. 11 is a perspective view of an example of a MEMS resonant sensor constructed in accordance with an exemplary embodiment of the invention.

FIG. 12 is a bottom view of a MEMS resonant sensor including a reference portion in accordance with an exemplary embodiment of the invention.

FIG. 13 is a bottom view of a MEMS resonant sensor adapted to detect multiple analytes in accordance with an exemplary embodiment of the invention.

FIGS. 14 and 15 are cross-sectional views of MEMS resonant sensors including capacitance detectors in accordance with exemplary embodiments of the invention.

FIG. 16 is a cross-sectional view of a MEMS resonant sensor including a strain detector in accordance with an exemplary embodiment of the invention.

FIG. 17 is a cross-sectional view of a MEMS resonant sensor including an optical detector in accordance with an exemplary embodiment of the invention.

FIG. 18 is a cross-sectional view of a MEMS resonant sensor including a screen in accordance with an exemplary embodiment of the invention.

FIG. 19 is a system constructed in accordance with another exemplary embodiment of the invention.

FIGS. 20 through 22 illustrate magnet locations according to some exemplary embodiments of the invention.

### DETAILED DESCRIPTION OF EXEMPLARY EMBODIMENTS

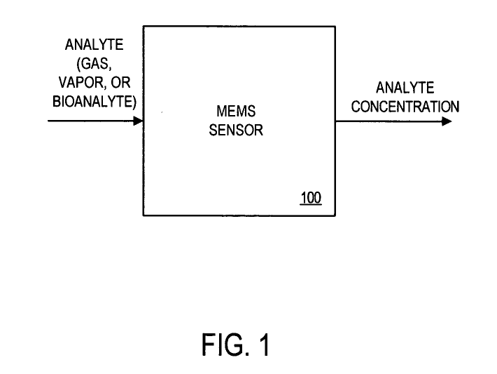

A resonant sensor may be used to determine if an analyte is present and/or to quantify an amount of “analyte.” As used herein, the term “analyte” may refer to any substance to be detected and/or quantified, including a gas, a vapor, and/or a bioanalyte. For example, FIG. 1 is a block diagram overview of a MEMS resonant sensor 100 that may be used to detect whether or not an analyte is present (and/or to determine an amount of analyte that is present). According to some embodiments, the sensor 100 is exposed to the analyte and generates an output indicating whether or not the analyte is present (e.g., whether or not the amount of CO₂ in the atmosphere exceeds a pre-determined level).

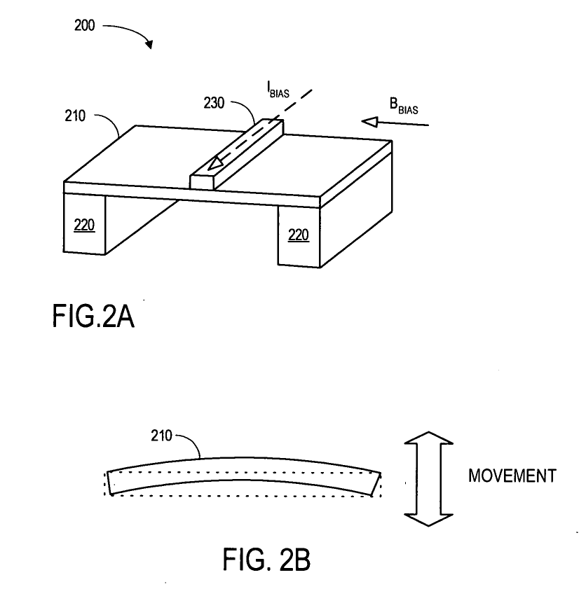

FIG. 2A is a perspective view of a MEMS apparatus 200 showing one possible embodiment. The apparatus 200 includes a spring element 210 anchored at opposite ends via supports 220. As used herein, the phrase “spring element” may refer to any flexible structure, such as a beam, plate, or membrane. Note that the spring element 210 might instead be anchored at only one end or around its periphery. According to some embodiments, the spring element 210 is a free-standing membrane made of silicon, silicon nitride, silicon carbide, epitaxial silicon, gallium nitride, polysilicon, parylene or other material. The membrane is suspended above, and substantially parallel to, a substrate such as a wafer.

A current I_{BIAS} flows through a conductor, such as a wire 230, located on, within, or in close proximity to the spring element 210. According to other embodiments, the current I_{BIAS} instead flows through the spring element 210 itself. A constant magnetic flux density or field B_{BIAS} is also present (e.g., stemming from a magnet or integrated coil not illustrated in FIG. 2A) and is substantially normal to an in the same plane as the flow direction of the current I_{BIAS}. As a result, the Lorentz force associated with current I_{BIAS} and the magnetic field B_{BIAS} will cause the spring element 210 to deflect upwards or downwards as illustrated in FIG. 2B.

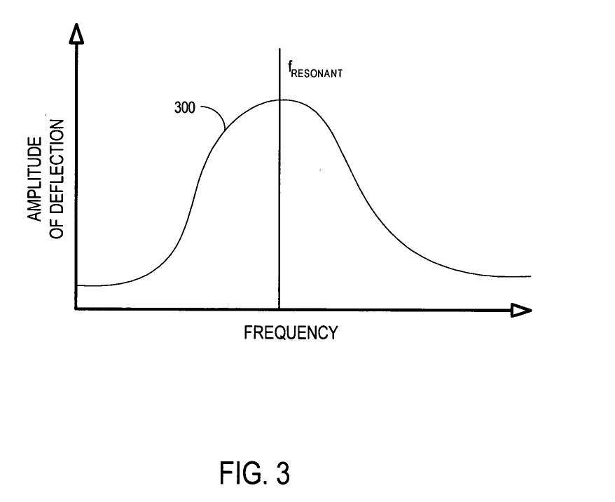

When the current I_{BIAS} is an Alternating Current (AC), the spring element 210 will vibrate between being deflected upwards and downwards. Moreover, the amplitude of deflection that is experienced by the spring element 210 at a constant bias current amplitude and for a given surrounding atmosphere will vary depending on the frequency of the current I_{BIAS}. For example, FIG. 3 is a graph 300 illustrating a normalized amplitude of deflection as a function of frequency. Based on the dimensions, materials, and mass associated with the apparatus 200, the spring element 210 will be associated with a resonant frequency (f_{RESONANT}) at which the amplitude of deflection will be at its maximum for that particular embodiment. Note that the shape of the curve illustrated in FIG. 3 is provided only for illustration, and a curve associated with an actual spring element 210 may have another shape.

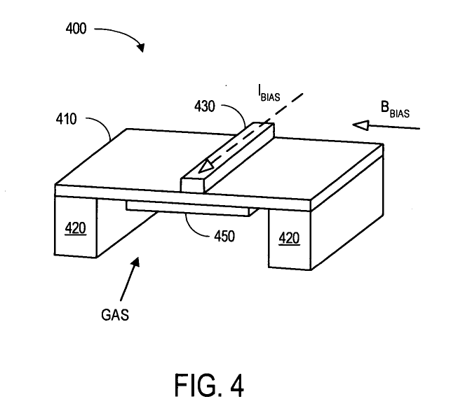

FIG. 4 is a perspective view of a MEMS apparatus 400 constructed in accordance with an exemplary embodiment of the invention. As before, the apparatus 400 includes a spring element 410 anchored at one end, opposite ends, or around its periphery via supports 420. An AC current I_{BIAS} flows through a conductor 430 on the spring element 410 and a constant magnetic field B_{BIAS} is present such that the spring element 210 will vibrate (in a direction substantially normal to a plane of a wafer).

According to this embodiment, a sensing material 450 is formed or deposited on the spring element 410 such that a resonant frequency associated with the spring element 210 will change when the sensing material 410 is exposed to an analyte. The sensing material 450 may provide a high selectivity which will have a sensitivity to a particular gas, vapor, or bioanalyte depending on its composition, physical, and chemical properties. That is, the presence of a first analyte or class of analytes (e.g., water vapor or alcohol) will change the resonant frequency while the presence of other analytes (e.g., N₂ and CO) will not. The sensing material 450 may be, for example, a thin film of zeolite, a polyelectrolyte, a carbon nanotube, mesoporous silicon/oxide, or other material applied to a surface of the spring element 410 opposite from the surface upon which the conductor 430 is mounted. According to another embodiment, the sensing material 450 may instead be formed on the same surface of the spring element 410 as the conductor 430.

The sensing material 450 may act as a chemical transducer. For example, the sensing material 450 may adsorb an analyte to be sensed and convert the adsorbed analyte into a mass, heat, stress, and/or strain change. In any of these cases, the frequency at which the spring element 410 will resonate will be altered (e.g., because the combined mass or stress of the spring element 410, conductor 430, and thin film sensing material 450 has been changed). The sensing material 450 may be, for example, an organic material (e.g., a polymer or copolymer), an inorganic material (e.g., a zeolite, a carbon nanotube, or ceramic material), or an organic/inorganic composite or nanocomposite. Moreover, the sensing material 450 may be nanostructured (e.g., exhibiting nanomorphologies by contrast to bulk crystalline or amorphous morphologies).

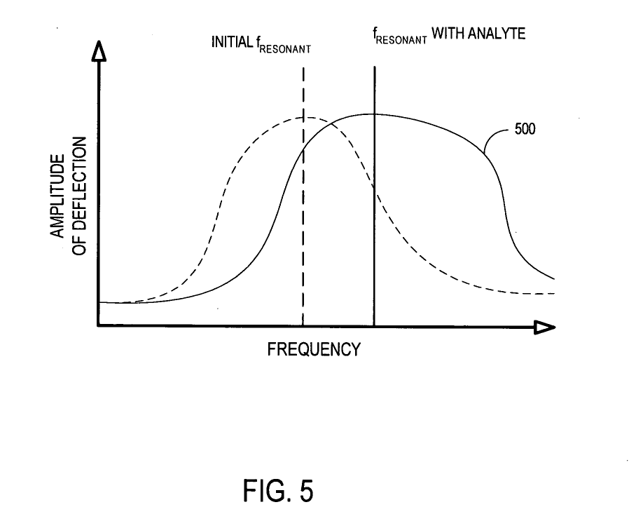

Assume, for example, that the dashed curve in FIG. 5 illustrates the amplitude of deflection as a function of frequency of the sensing material 450 prior to exposure to an analyte (and resonant frequency f_{RESONANT} is illustrated by a solid line). Moreover, the curve 500 illustrates the amplitude of deflection as a function of frequency after the sensing material 450 has been exposed to that analyte (and the altered resonant frequency f_{RESONANT} is illustrated by a dashed line). As can be seen, the resonant frequency f_{RESONANT} has decreased.

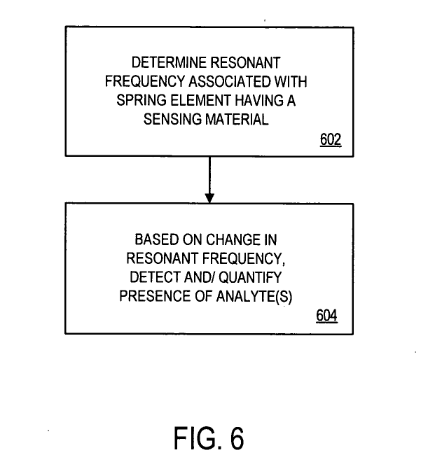

FIG. 6 illustrates a method that may be used to detect and/or quantify the presence of a particular analyte according to an exemplary embodiment of the invention. At Step 602, the resonant frequency associated with a spring element having a sensing material is determined. For example, an amplitude-measuring device might measure an amplitude of deflection over a range of frequencies and determine that the frequency associated with the largest deflection is the resonant frequency. Based on a change in the resonant frequency, the presence and amount of an analyte can be determined.

The materials used as the sensing material 450 will determine the analyte or analytes that can be detected. For example, when the analyte to be detected is CO an appropriate sensing material 450 might be a layer that includes ZSM-5, MFI, a polymer, a nonocomposite, and/or other materials. As another example, when the analyte is CO₂ the sensing material 450 might be a layer that is comprised of ZS500A, Zeochem Z10-02, SAP-34, carbon nanotubes, AFR, and/or other materials. When the analyte is O₂ the sensing material 450 could be a layer of A-type zeolites, zeolite SX6, and/or zeolite rho. As yet another example, when the analyte is ammonia the sensing material 450 may include zeolite 4A, zeolite 5A, zeolite 13X, FAU, and/or polyelectrolytes.

A sensing material 450 comprised of zeolites SX6, CaX, LTA, and/or zincophosphate might be used, for example, to detect N₂. Moisture or humidity (e.g., H₂O) might be detected using polyelectrolytes (e.g., polystyrene sulfonic acid) and/or A-zeolite. As another example, when the analyte to be detected is CH₄ the sensing material 450 might be a layer of LTA and/or zincophosphate. Moreover, NA-Y could be used to detect NOx.

When the sensing film is a zeolite, the selectivity can be achieved based on molecular size exclusion, molecular geometry exclusion, and/or electrostatic interactions between the analyte and the sensing material (e.g., polarity). The pore size in zeolitic structures may be controlled by the AL/Si atomic ratio and the synthesis parameters (e.g., temperature and pressure).

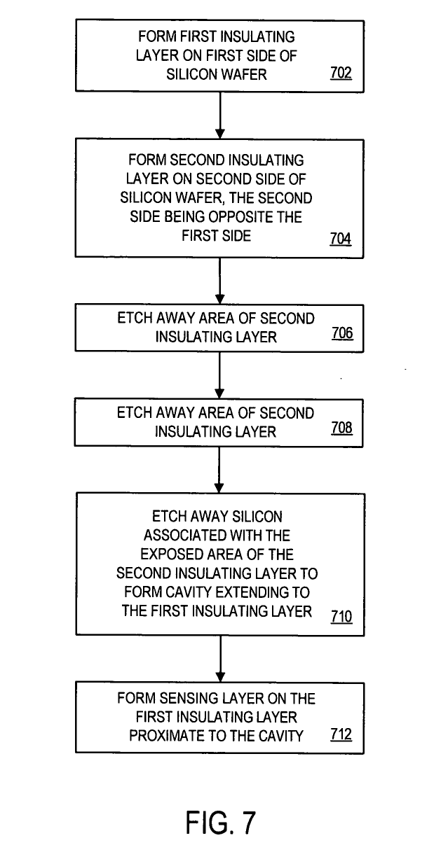

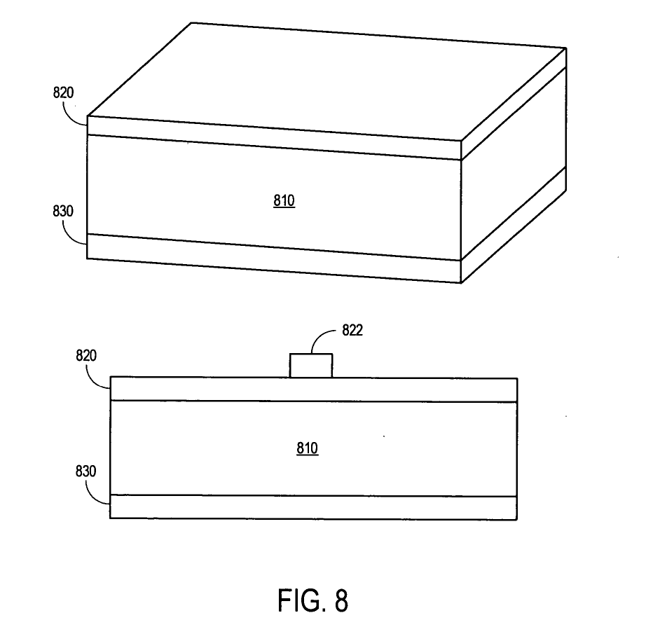

FIG. 7 illustrates a method of fabricating a MEMS resonant sensor in accordance with an exemplary embodiment of the invention. At Step 702, a first insulating layer is formed on a first side of a silicon wafer and a second insulating layer is formed on a second side of the silicon wafer (opposite the first side) at Step 704. For example, FIG. 8 illustrates perspective and cross-section views of a silicon wafer 810 with a top layer 820 and a bottom layer 830 each consisting of a thin film of amorphous silicon nitride (SiNx). Note that the wafer 810 might instead be in the shape of a disk (as opposed to a rectangle).

At Step 706, a conducting layer is deposited and patterned on the first insulating layer. For example, the cross section view of FIG. 8 illustrates a conductor 822 on the top layer 820. The conductor 822 might be a layer of, for example, platinum, aluminum, gold, doped single crystal silicon, doped poly-silicon, doped epitaxy silicon, or silicon carbide that has been deposited and pattered.

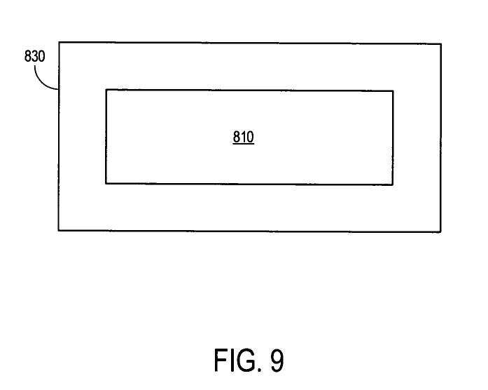

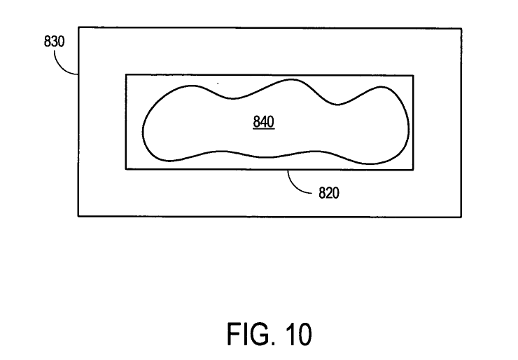

At Step 708, an area of the second insulating layer is etched away. At Step 710, silicon associated with the exposed area of the second insulating layer is etched away to form a cavity that extends through the wafer thickness to the first insulating layer. As a result, the portion of the first layer suspended over the cavity acts as a flexible membrane (and is supported by the wafer that surrounds the cavity). Consider, for example, FIGS. 9 and 10 which are bottom views of the structure shown in FIG. 8 after wet and dry etching techniques have been used (i) to remove a rectangular area of the bottom portion 830, thus exposing the wafer 810 as illustrated in FIG. 9 and (ii) to remove the portion of the wafer 810 associated with that area—creating a rectangular cavity in the wafer and exposing the bottom of the top layer 820 as illustrated in FIG. 10. Note that the cavity could instead be circular or any other shape.

A sensing layer is then formed on first insulating layer proximate to the cavity at Step 712. For example, FIG. 10 illustrates a structure after suitable deposition techniques have been used to coat the bottom of the top layer 820 (e.g., the suspended membrane) with a sensing material 840. Note that according to various embodiments, the sensing material 840 could cover some, all, or more of the top layer 820. Another possible embodiment would have the sensing material 840 covering the top of the top layer 820.

According to some embodiments, a sensing layer is formed proximate to the cavity and then a sensing material is added to the sensing layer. Consider, for example, a MEMS sensor that may be used to detect and/or quantify the presence of CO₂. In this case, the sensing material might be a single carbon nanotube or a plurality of carbon nanotubes. Note that the carbon nanotubes might be single wall (SWNT) or multi-wall (MWNT) carbon nanotubes. Moreover, the carbon nanotubes might be added to the sensing layer via solution deposition of dispersed nanotubes in an appropriate solvent.

MWNTs and SWNTs can be dispersed in a number of non-aqueous solvents, including 1,2-dichlorobenzene (12-DCB), chloroform (CHCl₃) or dimethylformamide (DMF), to allow for their effective deposition onto the sensing layer. Mechanical stirring or more effective low-intensity sonication (water bath) might be used to aid in the dispersion of the nanotubes in the chosen solvent. The resulting MWNT or SWNT solutions can be drop-cast or spin-cast onto the sensing layer to deposit the respective nanotubes therein. The relatively high volatility of CHCl3 and DMF enables convenient nanotube deposition.

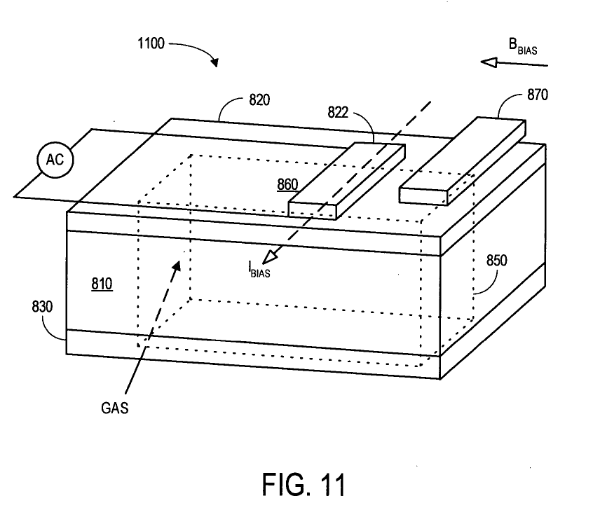

FIG. 11 is a perspective view of an example of a MEMS resonant sensor 1100 constructed in accordance with an exemplary embodiment of the invention. The sensor 1100 includes the wafer 810, top layer 820, conductor 822, and bottom layer 830 that have been etched as described with respect to FIGS. 9 and 10 to create a cavity 850 and a suspended membrane 860 above the cavity 850. The sensing material 840 has also been applied to the bottom of the suspended membrane 860 (but is not illustrated in FIG. 11 for clarity).

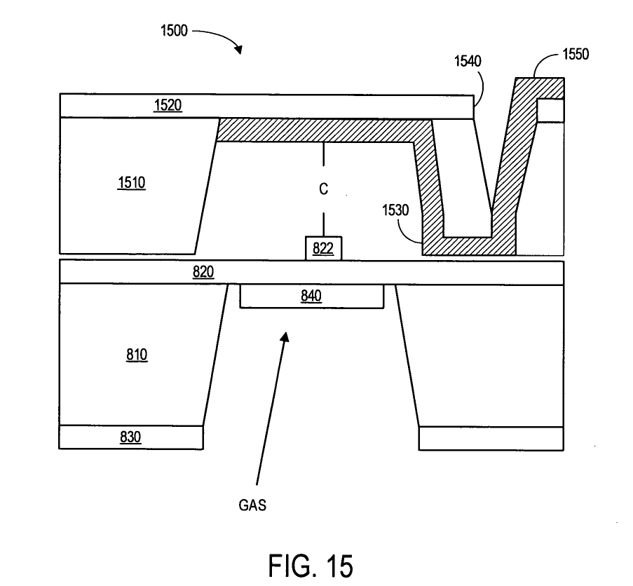

An AC source and the conductor 822 (e.g., doped silicon, platinum, or other conducting material) provides current IBIAS and a magnet 870 (e.g., a permanent magnet, a solenoid, or an integrated coil) creates a constant magnetic field BBIAS such that current IBIAS will cause the membrane 860 to vibrate. The resonant frequency of the membrane 860 will depend in part on the analytes found in gas mixture that enters the cavity 850 and is physically adsorbed by the sensing material 840. In this way, a detector adapted to determine the resonant frequency can be used to measure and quantify the presence of an analyte, and some examples of detectors are described with respect to FIGS. 15 through 17.

Such an approach may provide a sensitive, selective, fast responding, robust, and accurate analyte detector. Moreover, the design can be used to detect different analytes and/or different amounts of analytes (e.g., by changing the materials used in the sensing material 840 and/or the geometry of the membrane 860 and/or the material used to fabricate the membrane).

Note that after a target analyte has been adsorbed by the sensing material 840, the analyte would need to be removed before the sensor would be able take another measurement. To accelerate the removal of the analyte from the sensing material 840, micro-heaters may be used to temporarily increase the temperature of the sensing material 840 (causing the desorption of the analyte from the sensing material 840). Other methods can be used to accelerate the desorption of the analyte from the sensing material 840, including exposure to light at specific wavelengths. According to some embodiments, the conductor 822 carrying current IBIAS may be used as a micro-heater. According to other embodiments, one or more separate micro-heaters may be used instead of (or in addition to) the conductor 822.

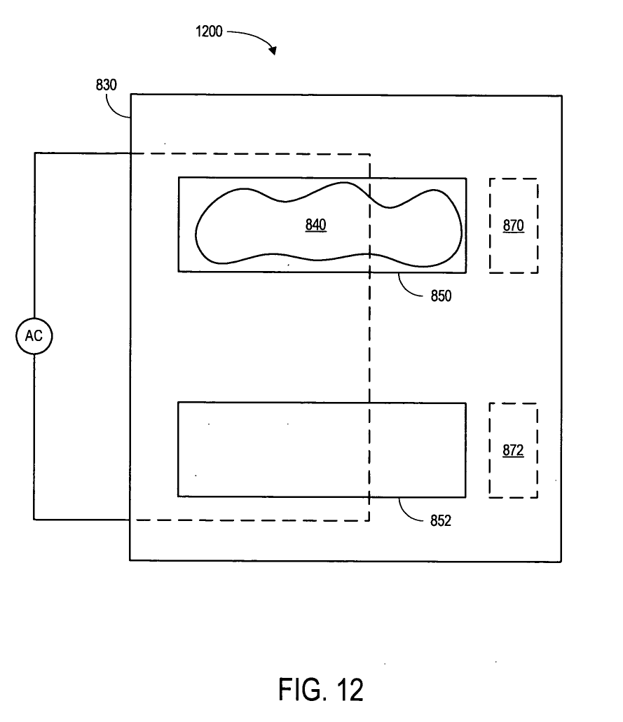

Also note that the resonant frequency of the membrane 860 could change because of factors other than the adsorption process. For example, a substantial change in pressure and/or temperature might change the resonant frequency of the membrane 860—which could affect the measurement and quantification of the target analyte. FIG. 12 is a bottom view of a MEMS resonant sensor 1200 that includes a reference portion in accordance with an exemplary embodiment of the invention. As before, an AC source provides current I_{BIAS} and a magnet 870 provides magnetic field B_{BIAS} such that a membrane over a cavity 850 can be excited over a range of frequencies. In addition, a sensing material 840 is provided on the bottom of the membrane associated with the cavity 850 such that the resonant frequency of that membrane will change when the sensing material 840 is exposed to an analyte. In this embodiment, however, another “reference” cavity 852 is provided (along with another reference magnetic source 872)—and the bottom of the membrane suspended over the reference cavity 852 is not coated with a sensing material. Note that separate AC sources and/or a single magnetic could instead be used. In another embodiment, the reference cavity 852 could be coated with a sensing layer having the same composition as the sensing material 840. The reference cavity 852 could be sealed to the gas, vapor, or bioanalyte so that the adsorption processes do not take place. This structure would be used as a reference for the measurements made by cavity 850 and would account for changes in stress or strain exerted on the membrane structure due to environmental changes.

In this way, the reference portion of the sensor 1200 may be used to determine if a change in resonant frequency is due to a factor other than the presence of the analyte. For example, a change in temperature might change the resonant frequency of the membranes over both the first cavity 850 and the reference cavity 852 an equal amount (and therefore the sensor 1200 would not generate an output indicating that the analyte is present). A change in the resonant frequency of the membrane over the first cavity 850, however, without a corresponding change in the membrane over the reference cavity 852 would generate such an output.

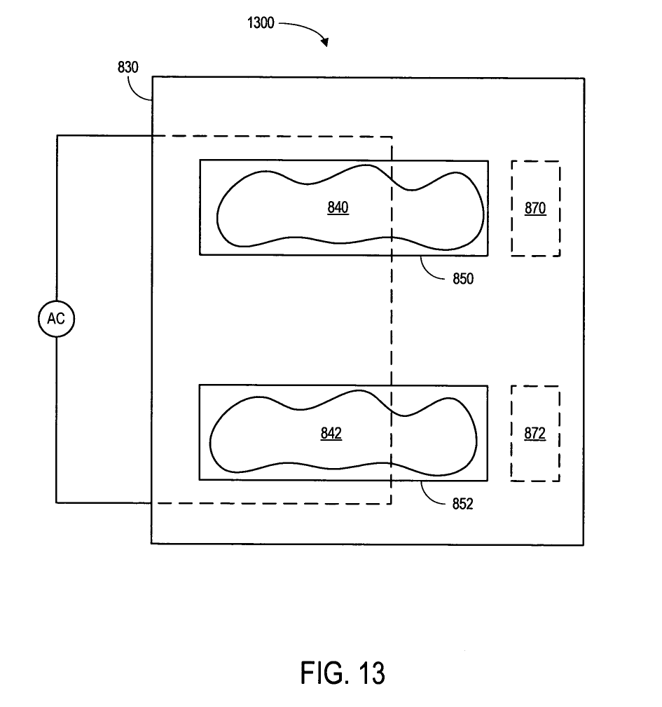

FIG. 13 is a bottom view of a MEMS resonant sensor 1300 adapted to detect multiple target analytes in accordance with another exemplary embodiment of the invention. As before, an AC source provides current I_{BIAS} and a first magnet 870 provides magnetic field B_{BIAS} such that a membrane over a first cavity 850 can be excited over a range of frequencies. In addition, a first sensing material 840 is coated on the bottom of the membrane associated with the first cavity 850 such that the resonant frequency of that membrane will change if the sensing material 840 is exposed to a first analyte. Moreover, in this embodiment a second cavity 852 is provided (along with a second magnetic source 872)—and the bottom of the membrane suspended over the second cavity 852 is coated with a second sensing material 842 made of a material different than the material used to create the first sensing material 840. The material of the second sensing portion 842 would be sensitive to adsorption of a different gas, vapor, or bioanalyte. In this way, the sensor 1300 may be used to determine if multiple analytes are present. Note that such an approach might be used in combination with the reference membrane approach described with respect to FIG. 12 (e.g., and there might be three or more cavities depending on the number of analytes to be detected). Another embodiment would be composed of multiple sensors having individual sensing and reference cavities each with different sensing materials configured as an array. When this sensor array is exposed to an analyte mixture, the individual target substances will be more sensitive to one sensing material than the rest of the sensing materials. Thus, this selectivity may create a signal signature for various target substances inn an analyte mixture.

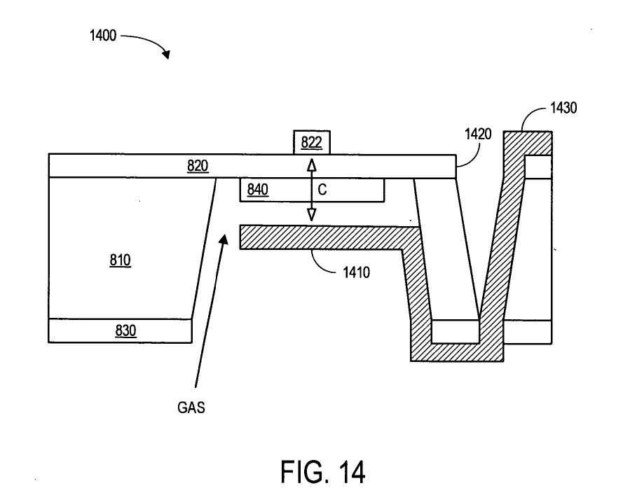

To determine the resonant frequency of a spring element, a detector may sample amplitudes of deflection over a range of frequencies driven from the current conductor layer. The frequency associated with the greatest deflection can then be identified as the resonant frequency. FIGS. 14 through 17 illustrate various embodiments to determine deflection according to different scientific approaches.

In particular FIG. 14 is a cross-sectional view of a MEMS resonant sensor 1400 that uses capacitance-based detection in accordance with an exemplary embodiment of the invention. As before, a portion of a top layer 820 (e.g., the membrane portion) is suspended over a cavity formed in a wafer 810 and a bottom layer 830. The top of the membrane has a conducting path 822 and the bottom has a sensing material 840. According to this embodiment, an electrode 1410 is provided near the bottom of the membrane (and therefore near the conducting path 822). The electrode 1410 might be, for example, a ground plane made of electrically conductive material such as doped Si or a metal. The electrode 1410 travels through a via 1420 and ends at a contact 1430. In this way, the amplitude of deflection of the membrane is associated with an amount of capacitance C between the electrode 1410 and the conducting path 822. That is, a change in distance between the conducting path 822 and the electrode 1410 will change the capacitance C. In another embodiment, the electrode 1410 could be mounted on another wafer that is bonded to layer 830 (not illustrated in FIG. 14). In still another embodiment, the via through the wafer could be eliminated and electrical output be taken from the backside of the device. Also note that holes could be provided in the electrode 1410 to let gas, vapor, and/or bioanalyte more easily reach the sensing material 840.

FIG. 15 is a cross-sectional view of another MEMS resonant sensor 1500 that uses capacitance-based detection. As before, a portion of a top layer 820 (e.g., the membrane portion) is suspended over a cavity formed in a wafer 810 and a bottom layer 830. The top of the membrane has a conducting path 822 and the bottom has a sensing material 840. According to this embodiment, a second wafer 1510 with a second insulating layer 1520 is placed above the membrane. The second wafer 1510 has an electrode 1530 located near the top of the membrane (and therefore near the conducting path 822). The electrode 1530 travels through a via 1540 and ends at a contact 1550. In this way, the amplitude of deflection of the membrane is associated with an amount of capacitance C between the electrode 1530 and the conducting path 822. In another embodiment, the electrode 1530 would terminate on an electrical contact located on the topside of the layer 820 rather than using the via 1540.

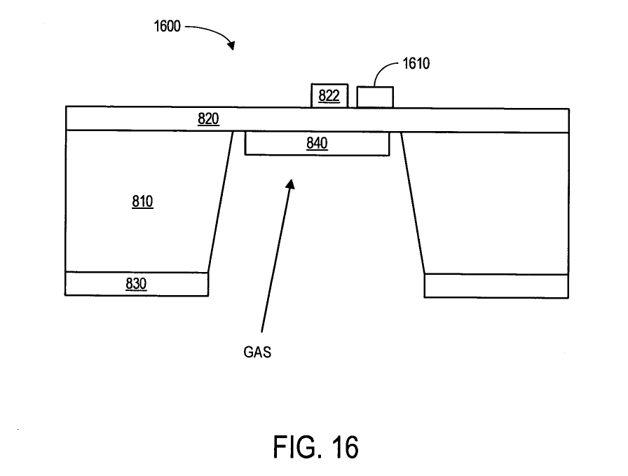

FIG. 16 is a cross-sectional view of a MEMS resonant sensor 1600 including a strain detector in accordance with an exemplary embodiment of the invention. A portion of a top layer 820 (e.g., the membrane portion) is suspended over a cavity formed in a wafer 810 and a bottom layer 830. The top of the membrane has a conducting path 822 and the bottom has a sensing material 840. According to this embodiment, a strain gauge 1610 is positioned on and around the membrane. The strain gauge 1610 might be, for example, associated with a piezoresistor, a metal (e.g., Ni), a Giant Stress Impedance (GSI) material, and/or a magnetoelastic material. In this way, the amplitude of deflection of the membrane can be measured by measuring the strain that is caused by the deflection.

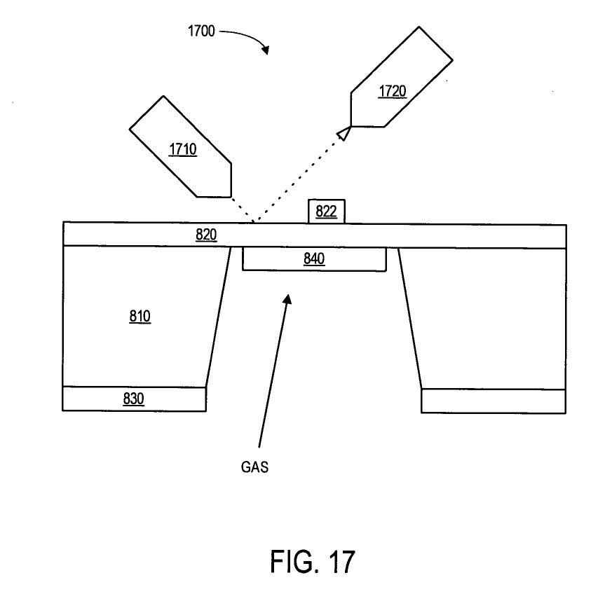

FIG. 17 is a cross-sectional view of a MEMS resonant sensor 1700 including an optical detector in accordance with an exemplary embodiment of the invention. Once again, a portion of a top layer 820 (e.g., the membrane portion) is suspended over a cavity formed in a wafer 810 and a bottom layer 830. The top of the membrane has a conducting path 822 and the bottom has a sensing material 840. According to this embodiment, an optical source 1710 (e.g., a laser diode) transmits light onto the membrane and an optical detector 1720 catches light as it reflects off of (or escapes from) the membrane. In this way, the amplitude of deflection of the membrane can be measured based on an optical characteristic of the membrane. For example, a change in angle of deflection (e.g., caused by a curve in the membrane when it deflects) or an interference pattern might be used to determine the amplitude of membrane movement. In another embodiment, the optical source 1720 could integrate the membrane through the cavity.

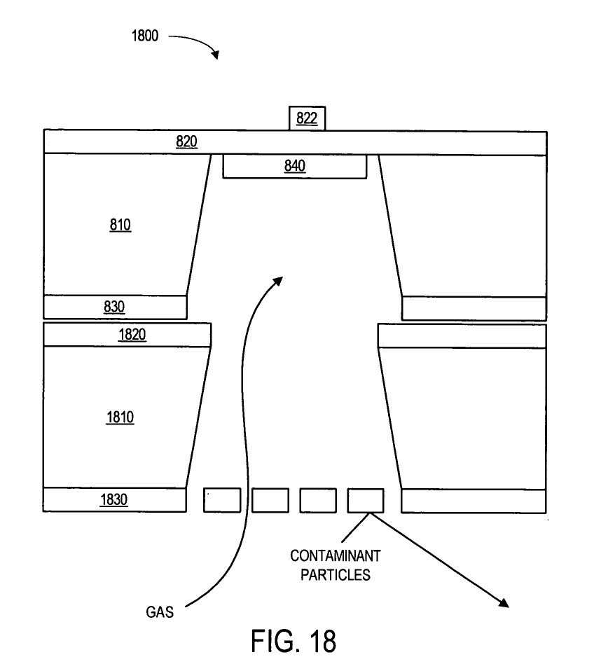

As described with respect to FIG. 11, after an analyte has been adsorbed by a sensing material, a micro-heater may be used to help desorb the analyte from the sensing material. In some cases, however, the sensing material might be exposed to an impure gas and contaminant particles (such as particles of dirt) could become locked into the sensing material. As a result, the sensing material and spring element might be unable to properly refresh the structure due to contamination (and the sensor would no longer be usable). To address this situation, FIG. 18 is a cross-sectional view of a MEMS resonant sensor 1800 wherein a portion of a top layer 820 (e.g., the membrane portion) is suspended over a cavity formed in a wafer 810 and a bottom layer 830. The top of the membrane has a conducting path 822 and the bottom has a sensing material 840. According to this embodiment, a second wafer 1810, top layer 1820 and bottom layer 1830 are provided under the opening of the cavity. Moreover, the bottom layer 1830 includes a screen that may help prevent contaminant particles from reaching the sensing material. The screen could also be fabricated on the top layer 1820. The pores in the screen may be customized to prevent particles of a specific size distribution from reaching the membrane and locking the sensing portion. The screen might be made of, for example, mesoporous silicon, oxide, nitride structures, or any other material. Also note that other packaging might be provided to protect the sensor 1800 from, for example, noise parameters such as Electro-Magnetic Interference (EMI).

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

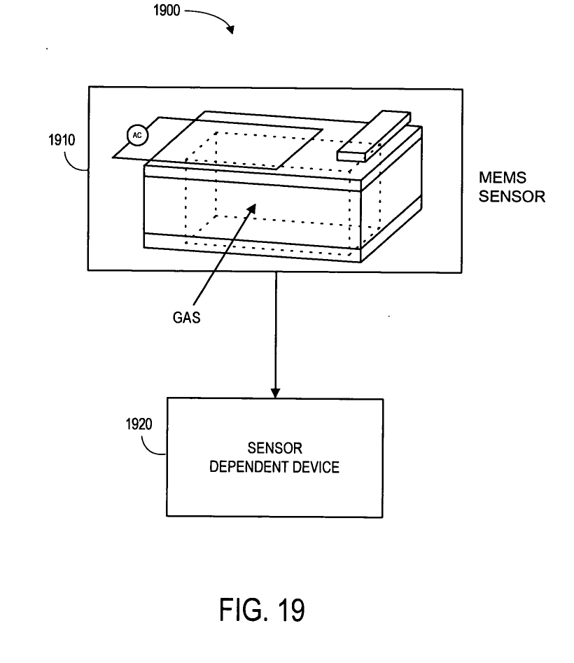

For example, a MEMS resonant sensor could be associated with a system 2000 such as the one illustrated in FIG. 19. The system 1900 includes a MEMS resonant sensor 1910 that operates in accordance with any of the embodiments described herein. For example, the MEMS resonant sensor 1910 might include: (i) a spring element, (ii) a sensing material on the spring element, and (iii) a detector adapted to determine a resonant frequency associated with the spring element, wherein the resonant frequency will shift when the sensing material is exposed to an analyte at a specific concentration.

Information from the MEMS resonant sensor 1910 is provided to a sensor dependent device 1920 (e.g., via an electrical signal). Such a system 1900 might be associated with, for example, a consumer device (e.g., an alarm to be used in a home), an industrial process control device, or a Heating, Ventilation, Air Conditioning (HVAC) device. Some medical examples include a breath analyzer, a blood alcohol measuring device, and a blood glucose monitor device. Similarly, the system 2000 might be an air quality device, an emissions management device, a leak detector, a poison detector, a flammable material detector, a chemical weapon detector, a toxic material detector, an explosive material detector, a hydrogen economy detector, a pharmaceutical process control device, and/or a bioanalyte sensor. Note that the system 1900 might be associated with any combination of these examples.

Moreover, although particular layouts have been described herein, embodiments may be associated with other layouts. For example, according to some embodiments, only one end of a spring element might be anchored and/or the spring element might be a beam. As another example, a spring element could be supported above a wafer (instead of being suspended over a well). Similarly, a MEMS resonant sensor could use any combination of amplitude detection techniques described herein. Some embodiments might simply keep the frequency of current I_{BIAS} constant and measure the amplitude of deflection (e.g., when any amount of an analyte to be detected will reduce the amount of deflection). As still another example, the velocity at which the spring element moves might be measured.

According to some embodiments, a sensor will always scan through a pre-determined set of frequencies (e.g., from an f_{MIN} to an f_{MAX}). According to another embodiment, the sensor may sample a mid-range frequency and then select the next frequency to be sampled (e.g., higher or lower than the last sampled frequency by smaller and smaller increments). For example, the sensor might initially sample the amplitude of deflection when current I_{BIAS} has the following frequencies: f_{MIN}, f₁, f₂, and f_{MAX}. If f₂ had the greatest maximum amplitude of deflection, then the next two frequencies to be sampled might be (f₁+f₂)/2 and (f₂+f_{MAX})/2.

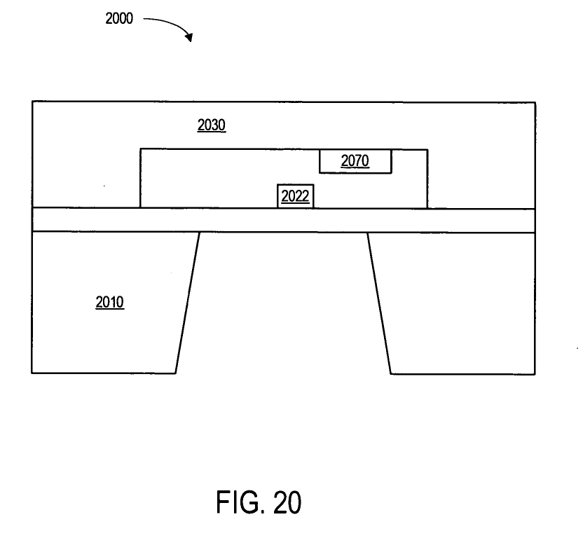

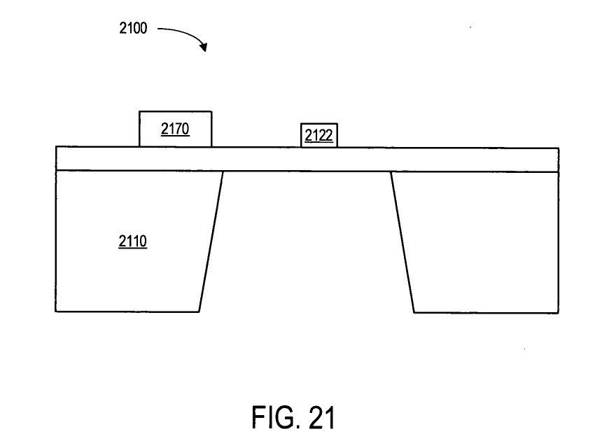

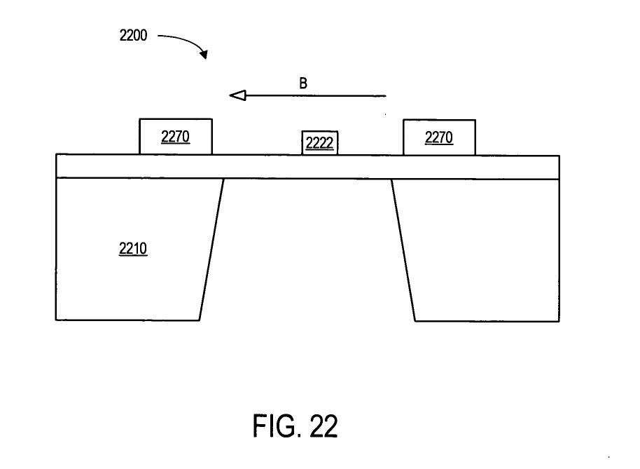

Some embodiments have described a magnetic source that provides a magnetic field B. Note that such a magnet force may be provided and/or located in any number of different ways. For example, FIGS. 20 through 22 illustrate magnet locations according to some exemplary embodiments of the invention. In particular, FIG. 20 is a sensor 2000 in which a wire 2022 is provided on a first wafer 2010. According to this embodiment, a magnet 2070 is attached to a second wafer 2030 and is in close proximity to the wire 2022. As another approach, FIG. 21 illustrates a sensor 2100 with a magnet 2170 mounted on the same wafer 2110 as the wire 2122. In yet another embodiment, FIG. 22 is a cross-sectional view of a sensor 2200 having a coil magnet 2270 (generating magnetic field B) located on the same wafer 2210 as the wire 2222. Note that in any of these embodiments, a magnet might be in-plane or out-of-plane with respect to the conducting wire.

In addition, in some embodiments a resonant frequency measuring device might be used to measure the resonant frequency shift directly. For example, second resonator might be used to measure such a shift.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A microelectromechanical system sensor, comprising:
a spring element;
a sensing material on the spring element; and
a detector adapted to determine a resonant frequency associated with the spring element, wherein the resonant frequency changes upon the exposure of the sensing material to an analyte.

2. The sensor of claim 1, wherein the detector includes:
a conducting path through which an alternating current is to flow; and
a magnet field source having a magnetic field substantially normal to direction of current flow through the conducting path.

3. The sensor of claim 2, further comprising:
a wafer substantially parallel to and supporting the spring element, wherein a Lorenz force moves the spring element in a direction substantially normal to the wafer.

4. The sensor of claim 3, wherein the detector further comprises:
an amplitude measuring device, wherein the amplitude of spring element movement is measured over a plurality of alternating current frequencies to determine the resonant frequency.

5. The sensor of claim 4, wherein the amplitude measuring device comprises:
a conducting plane proximate to the conducting path wherein the amplitude is associated with an amount of capacitance between the conducting plane and conducting path.

6. The sensor of claim 4, wherein the amplitude measuring device comprises at least one of: (i) a direct current strain gauge, wherein the amplitude is associated with an amount of strain created by the movement of the spring element, and (ii) an alternating current stress gauge, wherein the amplitude is associated with an amount of stress created by movement of the spring element.

7. The sensor of claim 4, wherein the amplitude measuring device comprises:
an optical source; and
an optical detector, wherein the amplitude is associated with an optical characteristic of the spring element.

8. The sensor of claim 1, wherein the spring element comprises at least one of: (i) a free standing membrane, (ii) a cantilever beam, and (iii) a bridge structure.

9. The sensor of claim 1, further comprising:
a reference spring element; and
a reference detector adapted to determine a reference resonant frequency associated with the reference spring element, wherein the reference resonant frequency does not change upon the exposure of the reference spring element to the analyte.

10. The sensor of claim 1, further comprising:
a second spring element;
a second sensing material on the second spring element; and
a second detector adapted to determine a second resonant frequency associated with the second spring element, wherein the second resonant frequency changes upon the exposure of the second sensing material to a second analyte.

11. The sensor of claim 1, further comprising:
a screen to help prevent contaminant particles from reaching the sensing material.

12. The sensor of claim 1, wherein the analyte is CO and the sensing material is a layer that includes at least one of: (i) ZSM-5, and (ii) MFI.

13. The sensor of claim 1, wherein the analyte is CO₂ and the sensing material is a layer that includes at least one of: (i) ZS500A, (ii) Zeochem Z10-02, (iii) SAP-34, and (iv) AFR.

14. The sensor of claim 1, wherein the analyte is O₂ and the sensing material is a layer that includes at least one of: (i) A-type zeolites, (ii) SX6, and (iii) zeolite rho.

15. The sensor of claim 1, wherein the analyte is ammonia and the sensing material is a layer that includes at least one of: (i) zeolite 4A, (ii) zeolite 5A, (iii) zeolite 13X, (iv) FAU, and (v) polyelectrolytes.

16. The sensor of claim 1, wherein the analyte is N₂ and the sensing material is a layer that includes at least one of: (i) SX6, (ii) CaX, (iii) LTA, and (iv) zincophosphate.

17. The sensor of claim 1, wherein the analyte is H₂O and the sensing material is a layer that includes at least one of: (i) polyelectrolytes, (ii) A-zeolite, and (iii) polystyrene sulfonic acid.

18. The sensor of claim 1, wherein the analyte is CH₄ and the sensing material is a layer that includes at least one of: (i) LTA, and (ii) zincophosphate.

19. The sensor of claim 1, wherein the analyte is NOx and the sensing material is a layer that includes NA-Y.

20. The sensor of claim 1, wherein the analyte is aromatics and the sensing material is a layer that includes ZSM5.

21. The sensor of claim 1, wherein the analyte is hydro-fluorocarbons and the sensing material is a layer that includes NA-Y.

22. The sensor of claim 1, wherein the analyte is SO₂ and the sensing material is a layer that includes at least one of: (i) zeolite X, (ii) zeolite Y, and (iii) Na-P1.

23. The sensor of claim 1, wherein the analyte is alcohol and the sensing material is a layer that includes H-ZSM 5.

24. The sensor of claim 1, wherein the sensing material is at least one of: (i) a single carbon nanotube, and (ii) a plurality of carbon nanotubes.

25. The sensor of claim 24, wherein the analyte comprises CO₂.

26. The sensor of claim 25, wherein at least one carbon nanotube comprises at least one of: (i) a single wall carbon nanotube, and (ii) a multi-wall carbon nanotube.

27. A method of producing a microelectromechanical system sensor, comprising:
forming a first insulating layer of a first side of a silicon wafer;
forming a second insulating layer on a second side of the silicon wafer, the second side being opposite the first side;
depositing and patterning of current carrying conductor on the first insulating layer on the first side of the silicon wafer;
etching away an area of the second insulating layer;
etching away a portion of the silicon wafer associated with the area to form a cavity substantially reaching the first insulating layer; and
forming a sensing layer on the first insulating layer proximate to the cavity, wherein the sensing layer is to change a resonant frequency of the first insulating layer proximate to the cavity upon exposure to an analyte; and
providing a sensing material for the sensing layer.

28. The method of claim 27, wherein the sensing material comprises at least one of: (i) a single nanotube, and (ii) a plurality of nanotubes.

29. The method of claim 28, wherein at least one nanotube comprises at least one of: (i) a single wall carbon nanotube, and (ii) a multi-wall carbon nanotube.

30. The method of claim 29, wherein said providing comprises:
adding at least one carbon nanotube via solution deposition of dispersed nanotubes in an appropriate solvent.

31. The method of claim 28, wherein the analyte comprises CO₂.

32. A microelectromechanical system sensor, comprising:
a spring element;
a sensing material on the spring element; and
a detector adapted to determine a resonant frequency associated with the spring element, wherein the resonant frequency changes upon the exposure of the sensing material to an analyte, and wherein the detector includes:
a conducting path through which an alternating current is to flow, and
a magnet having a magnetic field substantially normal to direction of current flow through the conducting path;
a reference spring element; and
a reference detector adapted to determine a reference resonant frequency associated with the reference spring element, wherein the reference resonant frequency does not change upon the exposure of the reference spring element to the analyte.

33. The sensor of claim 32, further comprising:
a wafer substantially parallel to and supporting the spring element, wherein a Lorenz force moves the spring element in a direction substantially normal to the wafer.

34. The sensor of claim 33, wherein the detector further comprises:
an amplitude measuring device, wherein the amplitude of spring element movement is measured over a plurality of alternating current frequencies to determine the resonant frequency.

35. The sensor of claim 34, wherein the amplitude measuring device comprises:
a conducting plane proximate to the conducting path wherein the amplitude is associated with an amount of capacitance between the conducting plane and conducting path.

36. The sensor of claim 34, wherein the amplitude measuring device comprises:
a strain gauge, wherein the amplitude is associated with an amount of strain created by the movement of the spring element.

37. The sensor of claim 34, wherein the amplitude measuring device comprises:
an optical source; and
an optical detector, wherein the amplitude is associated with an optical characteristic of the spring element.

38. The sensor of claim 32, wherein the spring element comprises a silicon nitride membrane.

39. A method of detecting an analyte, comprising:
determining a resonant frequency associated with a spring element having a sensing material; and
based on the resonant frequency, detecting the presence of the analyte.

40. The method of claim 39, wherein said determining comprises:
measuring amplitudes associated with each of a plurality of frequencies; and
selecting the frequency having the greatest amplitude as the resonant frequency.

41. A method of producing a microelectromechanical system sensor, comprising:
forming a first insulating layer of a first side of a silicon wafer;
forming a second insulating layer on a second side of the silicon wafer, the second side being opposite the first side;
depositing and patterning of current carrying conductor on the first insulating layer on the first side of the silicon wafer;
etching away an area of the second insulating layer;
etching away the silicon wafer associated with the area to form a cavity that reaches the first insulating layer; and
forming a sensing layer on the first insulating layer proximate to the cavity, wherein the sensing layer is to change a resonant frequency of the first insulating layer proximate to the cavity upon exposure to an analyte.

42. A system, comprising:
a microelectromechanical system sensor, including:
a spring element,
a sensing material on the spring element, and
a detector adapted to determine a resonant frequency associated with the spring element, wherein the resonant frequency changes upon the exposure of the sensing material to an analyte; and
a sensor dependent device.

43. The system of claim 42, wherein the sensor dependent device is associated with at least one of: (i) a consumer device, (ii) an air quality device, (iii) an industrial process control device, (iv) a heating, ventilation, air conditioning device, (v) a breath analyzer, (vi) a blood alcohol measuring device, (vii) a blood glucose monitor device, (viii) an emissions management device, (ix) a leak detector, (x) a poison detector, (xi) a flammable material detector, (xii) a chemical weapon detector, (xiii) a toxic material detector, (xiv) an explosive material detector, (xv) a hydrogen economy detector, (xvi) a bioanalyte sensor, (xvii) a pharmaceutical process control device, and (xviii) an alarm.
